(19) United States
(12) Patent Application Publication
(10) Pub. No.: US 2006/0144653 A1
(43) Pub. Date: Jul. 6, 2006

(54) Brake unit for a rack-and-pinion drive

(76) Inventors: Johann Eberle, Irsee (DE); Karl Eiband, Marktobendorf (DE); Herbert Vogt, Maursjetten (DE)

Correspondence Address: ROTH & GOLDMAN, P.A., 523 W. 6TH STREET, SUITE 707, LOS ANGELES, CA, 90014, US

(21) Appl. No.: 10/561,893

(22) PCT Filed: Jul. 2, 2004
(86) PCT No.: PCT/EP04/07242

§ 371 Date: Dec. 22, 2005

(30) Foreign Application Priority Data
Jul. 18, 2003 (IT) T02003A000557

(51) Int. Cl. B60T 13/04

(52) U.S. Cl. 188/171

(57) ABSTRACT

The invention relates to a drive assembly for a carriage (13) that can be displaced preferably in a vertical manner. Said assembly comprises a stationary corresponding gear rack (1), with an assigned pinion of a drive motor (22) that is situated on the carriage and comprises a fail-safe brake (23) on the B end plate, said pinion being driven by a gear (21) to displace the carriage (13) in a vertical manner. An auxiliary carriage retaining device can be engaged if necessary to secure the vertically displaceable carriage (13). To obviate the need for manual work to increase the operational safety during the set-up of the carriage and its associated machine-tool, the retaining device is located on the carriage as an auxiliary brake unit (20) and is configured to engage directly in the gear rack (1) by means of its own pinion (2), which runs along inactively during the normal displacement of the carriage (13). The brake unit (20) can be operated independently of the fail-safe brake (23) of the drive motor (22).

The present invention relates to a brake unit for rack-and-pinion drives according to the pre-characterizing portion of patent claim 1. Rack-and-pinion-drives of this kind are used e.g. as vertical drives in general machine tool design—such as for gantry-type machine tools.

If a rack-and-pinion drive is used to effect vertical movement of a machine tool carriage, the carriage is provided with a drive motor operating a pinion meshing with the vertically extending rack so as to shift the carriage in a vertical direction. On its rear end—facing away from the rack—the prior art drive motor has on its B-end bearing plate an electromagnetically disengaged brake which, in the de-energized condition, is caused by compression springs to engage so as to bring the carriage to a standstill in its instantaneous (given) vertical position.

For reasons of safety, the prior aart design includes a so-called pin-on mechanism, i.e. the carriage can additionally be fixed in an instantaneous (given) vertical position by means of a pin or bolt adapted to be manually engageable with and introduced in the rack so that the carriage cannot “crash” in the case of improper handling, or of control errors or motor brake failure—e.g. if the operator has to perform set-up work under the carriage.

The prior art pin-on device as a safety feature is unsatisfactory at least from the viewpoint of the required additional labor because It has to be activated by hand: whenever installation work has to be performed underneath the carriage, the operator has to climb on the gantry to activate the device and again to release it after the work has been completed. On the basis of existing safety regulations, work without such an additional safety device is not possible or not permissible in order to keep the operator from sustaining severe physical damage as may be caused by unpredictable events.

On this basis, the object underlying the present invention is to improve the prior art brake unit for rack-and-pinion drives so that manual work pertinent to safety requirements is eliminated, yet stringent safety rules are fully observed as may be issued by pertinent regulatory bodies and call for reliable safety even if the operating brake is mishandled or falsely operated or if it fails altogether.

Another aspect of the underlying object is to be seen in the avoidance of undue space requirements on the machine tool.

These objects are attained by the features in patent claim 1. They provide for an additional brake unit for the rack-and-pinion drive to operate independently from the motor brake on the B-end plate of the drive motor and designed to be fall-safe. There is provided a second complete electromagnetically disengaged brake incuding a brake rotor on the carriage and having a pinion in mesh with the same or another rack. As a result, a second pinion is provided above or below or near the drive pinion proper of the electric motor on the rack, the second pinion locked or released for rotation by means of an independent brake rotor of an electromagnetically disengaged, and compression spring actuated brake (also referred to as “static-current actuated brake”).

The additional brake unit is designed to have a diameter as small as possible so as to not to lose too much free lifting length.

It is preferred for this unit to operate in the same plane as the drive motor so that both pinions may be equidistant to the rack.

It is contemplated to have this brake unit and the associated pinion to act on a second rack extending in parallel with the first rack.

An embodiment example of the present invention will now be described in greater detail under reference to the attached drawings.

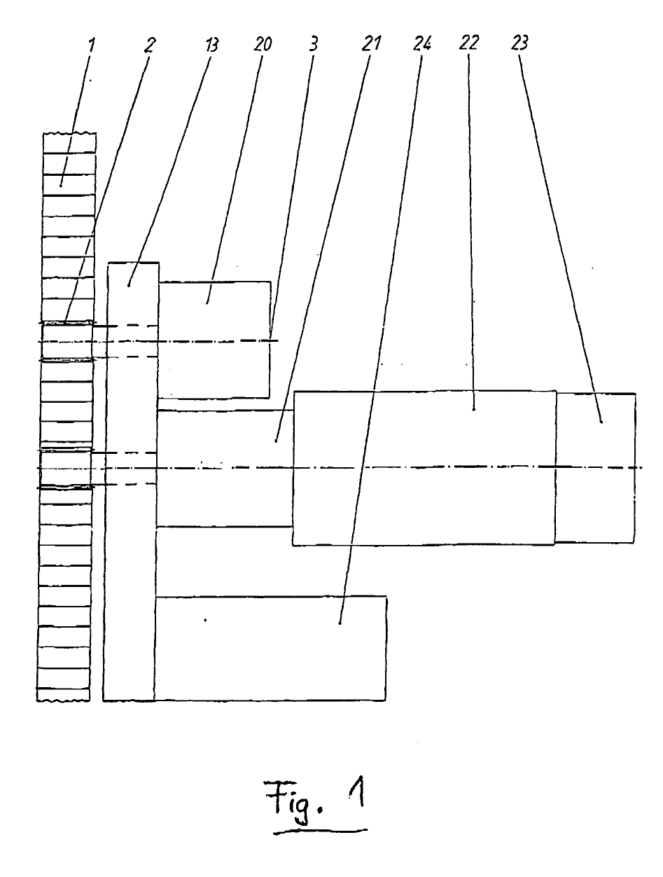

FIG. 1 schematically shows a basic possibility of constructing the carriage to move vertically along the rack and provided with an inventive brake unit:

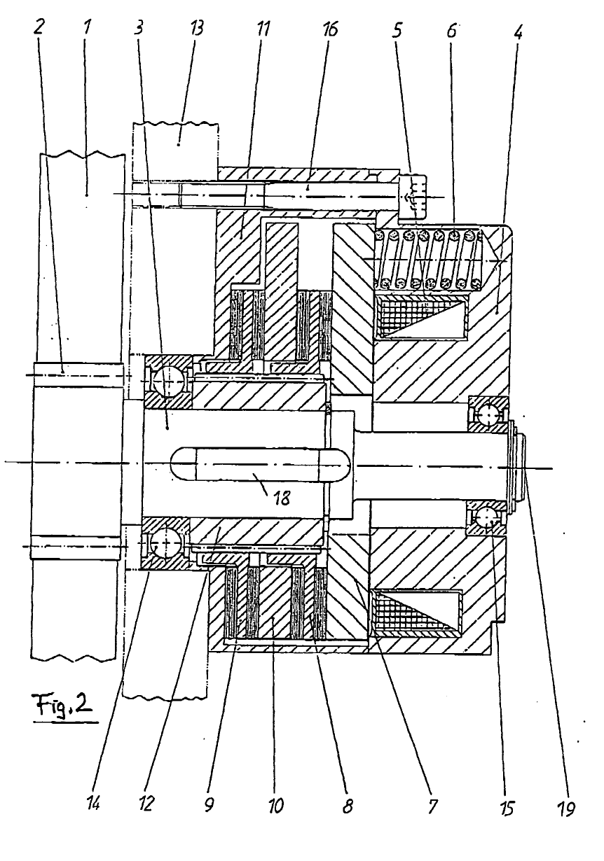

FIG. 2 shows a preferred embodiment of the inventive brake unit as an additional safety device for a vertical rack-and-pinion drive; and

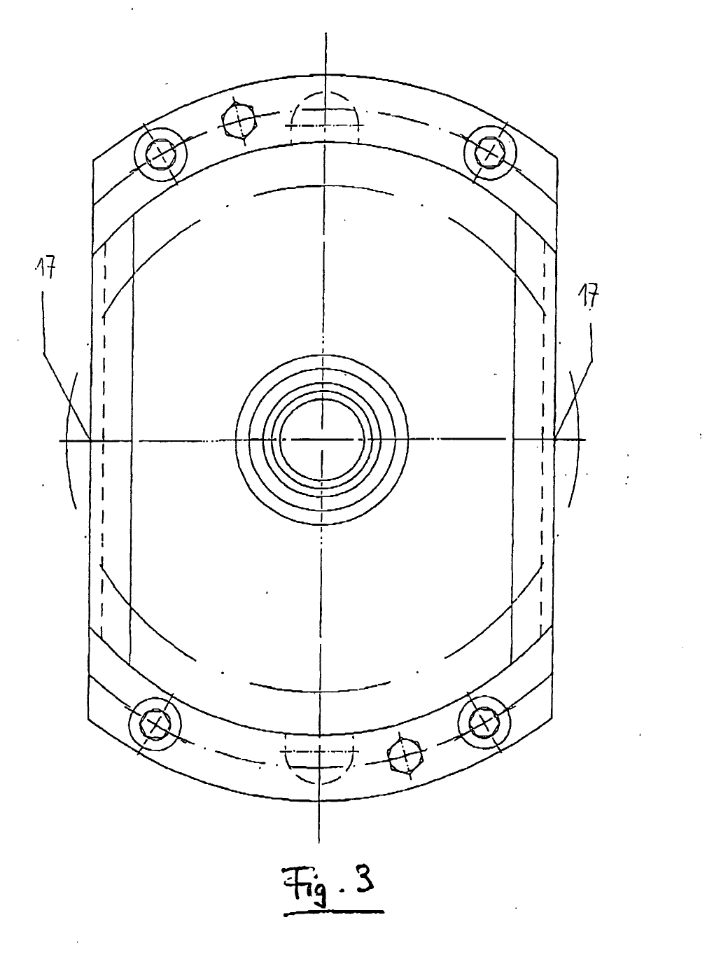

FIG. 3 shows a front view of the inventive brake unit.

In FIG. 1, reference numeral 1 designates the rack; on the right-hand side thereof is shown a conventional carriage drive including a drive motor 22, a brake 23 on the B-end bearing plate and a transmission or gearbox 21 to drive the pinion of the carriage along the rack.

Carriage 13 has at its lower end at 24 a tool platform mounting at the underside thereof any boring or milling tools or the like of which the vertical movement is effected by the carriage cooperating with rack 1.

In its fundamental configuration shown in FIG. 1, the additional complete brake unit 20, which is to be provided in accordance with the invention, is disposed above the conventional drive mechanism 21. 22. 23 and is coupled to pinion 2, which idles along on rack 1 as the carriage moves in the vertical direction.

A possible configuration of the complete additional brake unit is shown in FIG. 2. That brake assembly constitutes a brake unit which is disengaged by electromagnetical forces and, upon deenergization, is actuated by compression springs; despite a very small diameter it generates a high torque by comprising two brake rotors 8, 9 placed axially side by side and having two opposite friction linings each.

FIG. 2 shows a preferred design of brake unit 20, which, in this case, is an electromagnetically disengaged, compression spring actuated brake in which threaded fasteners 16 are used to secure the unit to the same carriage 13 as drive motor 22. Pinion 2 runs along rack 1 and preferably is formed to be integral with shaft 3 and splined hub 12—this in contradistinction to FIG. 2 where the sleeve of hub 12 is fixed on shaft 3 by means of a key 18 and a split washer. Shaft 13 is held by two antifriction bearings 14, 15 mounted at the greatest mutual distance possible. Bearing 14 has an outer diameter greater than that of pinion 2 and is located in a suitable opening in carriage 13,

Housing 11 of brake unit 20 encloses brake rotors 8, 9 which are mounted on hub 12 to rotate between the housing walls on the one hand and armature disc 7 of the static-current actuated brake on the othe hand, as well as an intermediate disc 10 mounted between the two rotors and fixed against rotation. Solenoid support 4 of the brake is constructed in the conventional way, i.e. it has a concentric solenoid coil 5 and circumferentially spaced compression springs 6 to urge armature disc 7 against rotors 8, 9 when the coil is deenergized. A particular aspect of solenoid support 4 is that bearing 15 is disposed at the outermost position of the solenoid support so as to mount and support shaft 3 in as stable a manner as possible.

The structural height of brake 20 can be kept small by machining portions of the brake away at two opposite positions so as to reduce its vertical dimension, i.e. the complete brake unit 20 can be made to lie nearer to drive unit 21, 22, 23 proper than would otherwise be the case. This aspect is shown in FIG. 3.

Pinion 2 of brake unit 20 will idle along in normal operation. In order to provide it with a proper bearing, the opposite distal end of the solenoid support of the brake—i.e. the rear end of the brake—has a bearing 15 or an antifriction bearing mounted therein to cooperate with front bearing 14 to result in a long distance along the shaft, whereby the pinion can more readily accept the forces generated when braking.

Another variant contemplated is that splined hub 12 of the brake and the rack pinion are formed to be integral so that the corresponding bearing 14 must be chosen to have a greater diameter. This design allows an additional key 18 for torque transmission to be eliminated.

In still another variant, the brake may comprise a pneumatic or a hydraulic brake.

Further, the possibility exists of using—instead of two brake rotors—multiple rotors in the manner of a multiple-disc brake so as to Increase the braking torque.

A still further important variant is contemplated in which one quarter of the width of pinion 2 of brake unit 20 is designed to constitute an oil felt pad for lubricating the rack, with the required lubricant supplied centrally through shaft 3 via a rotary leadthrough in end face 19.

### LIST OF REFERENCE CHARACTERS

1 rack
2 pinion
3 shaft (integral or with pinion 2 mounted thereon)
4 solenoid support/brake
5 solenoid/brake
6 spring
7 armature disc
8 rotor 1
9 rotor 2
10 intermediate disc
11 housing
12 splined hub
13 carriage (tool carriage, flange, housing wall or the like)
14 first bearing
15 second bearing (installed in rear end of brake)
16 threaded fasteners
17 flats (milled-away areas)
18 key
19 bore for rotary lubricant leadthrough
20 complete brake unit
21 transmission/gearbox
22 drive motor
23 brake
24 tool platform on carriage/holder for boring or milling tool

1. Drive assembly for a preferably vertically movable carriage (13), a correspondingly disposed stationary rack (1) of which the associated pinion is operable for vertically moving carriage (13) through a transmission (21) by means of a drive motor (22) having a static-current actuated brake (23) at the B-end bearing plate, with additional carriage retaining means provided and engageable as needed to secure the vertically movable carriage (13) in place, characterized by said retaining means comprising an additional brake unit (20) disposed on carriage (13) and adapted to cause a pinion (2) of its own to directly engage rack (1), with pinion (2) idling along with the normal movements of carriage (13), and with brake unit (20) adapted to be actuated independently from static-current brake (23) of drive motor (22).

2. Drive assembly as in claim 1, characterized in that, at the same time, shaft (3) of pinion (2) constitutes the shaft of brake rotor (8 or 9) and is supported by bearings (14, 15) disposed in opposite side walls of brake housing (11) or of solenoid support housing (4), respectively, so as to obtain the greatest possible distance between such bearings.

3. Drive assembly as in claim 1, characterized by brake unit (20) comprising as a static-current actuated, normally energized electromagnetic brake (4, 5, 6, 7).

4. Drive assembly as in claim 1, characterized by brake unit (20) being pneumatically or hydraulically actuated.

5. Drive assembly as in claim 1, characterized in that bearing (14) has a greater diameter than splined hub (12) of the brake so that shaft (3) is formed to be integral with hub (12).

6. Drive assembly as in claim 1, characterized by brake unit (20) having two or more brake rotors.

7. Drive assembly as in claim 1, characterized in that pinion (2) of brake unit (20) meshes with an additional stationary rack parallel with first rack (1).

8. Drive assembly as in claim 1, characterized in that pinion (2) of brake unit (20) is formed of felt material over a portion of its length for rack lubrication.

9. Drive assembly as in claim 8, characterized in that shaft (3) of pinion (2) has in end face (19) a rotary leadthrough for the introduction of lubricant to be supplied to the felt portion of pinion (2).

10. Drive assembly as in claim 1, characterized in that brake unit (20) is configured to have two parallel flats (17, FIG. 3) machined away for reducing its structural height, i.e. the distance thereof to drive motor (22) on carriage (13).
